(19) United States
(12) Patent Application Publication
(10) Pub. No.: US 2008/0145732 A1
(43) Pub. Date: Jun. 19, 2008

(54) Proton Exchange Fuel Cell

(76) Inventors: Ana Berta Lopes Correia Tavares, Milano (IT); Vincenzo Antonucci, Messina (IT); Antonio Zaopo, Milano (IT); Enza Passalacqua, Messina (IT); Alessandra Di Blasi, Messina (IT); Yuri A. Dubitsky, Milano (IT); Enrico Albizzati, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/792,493

(22) PCT Filed: Dec. 17, 2004
(86) PCT No.: PCT/EP04/14445

§ 371 Date: Jun. 7, 2007

(51) Int. Cl. H01M 8/10

(52) U.S. Cl. 429/30

(57) ABSTRACT

A proton exchange membrane fuel cell includes at least one membrane-electrode assembly including an electrolyte membrane based on a fluorine free polymer grafted with side chains containing proton conductive functional groups, and interposed between an anode and a cathode, the anode including a catalytic layer including a catalyst and a fluorinated ionomer. The catalytic layer has a fluorine/catalyst ratio that increases in a direction from the electrolyte membrane to an outer surface of the anode.

### BACKGROUND OF THE INVENTION

The present invention relates to a proton exchange membrane fuel cell, and to an apparatus comprising said fuel cell.

A typical fuel cell includes at least one membrane electrode assembly (MEA). Generally, MEA comprises an anode, a cathode and a solid or liquid electrolyte disposed between the anode and the cathode. Different types of fuel cells are categorized by the electrolyte used in the fuel cell, the five main types being alkaline, molten carbonate, phosphoric acid, solid oxide and proton exchange membrane (PEM) or solid polymer electrolyte fuel cells (PEFCs). A particularly preferred fuel cell for portable applications, due to its compact construction, power density, efficiency and operating temperature, is a proton exchange membrane fuel cell (PEMFC) which can utilize a fluid such as formic acid, methanol, ethanol, dimethyl ether, dimethoxy and trimethoxy ethane, formaldehyde, trioxane, or ethylene glycol as fuel.

### PRIOR ART

The majority of studies relating to PEMFC are focused on cells using methanol directly without a fuel reformer and referred to as DMFCs (direct methanol fuel cells).

Nowadays, portable equipments such as cellular phones, notebook computers and video cameras, are powered with rechargeable batteries, e.g. nickel-metal hydride or lithium ion batteries. The DMFC has the potential to replace rechargeable batteries for many applications, since it offers the promise of extended operating times together with easy and quick refueling, as reported, for example, by R. W. Reeve, “Update on status on direct methanol fuel cells”, DTI/Pub URN 02/592, Crown Copyright 2002.

In DMFC, methanol is oxidized to carbon dioxide at the anode and oxygen is reduced at the cathode according to the following reaction scheme:

Anode: CH₃OH+H₂O→CO₂+6H⁺+6e⁻;
Cathode: 3/2O₂+6H⁺+6e⁻→3H₂O;

### Overall: CH₃OH+3/2O₂→CO₂+2H₂O.

The performance of the DMFC is temperature dependent due to the kinetic limitations of the anode reaction, as the methanol oxidation kinetic is slower. Considering the kind of equipment to be powered, it is important to obtained the desired performance in term of power density (mW/cm) at a temperature as near as possible to the room temperature.

Besides the temperature, the performance of a DMFC depends on the MEA component materials.

The electrodes typically comprises platinum-rhutenium alloy (anode) and platinum (cathode) as reaction catalyst. The catalyst can be supported on carbon particles, for example carbon black, and a ionomer, usually a copolymer of tetrafluoroethylene and perfluoro-3,6-dioxa-4-methyl-7-octene-sulfonic acid Nafion® from DuPont Chemical Company) can be impregnated into the catalyst layer.

Commercially available electrodes for DMFC applications are ELAT® electrodes from E-TEK. ELATE electrodes are based on a three layer structure formed by a carbon cloth support, a gas-side wet proofing layer by means of a hydrophobic fluorocarbon/carbon layer on one side of the support only, and a catalytic layer of carbon black loaded with Pt or Pt/Ru.

As for the electrolyte membrane, its material should allow the proton diffusion from anode to cathode, and should prevent the fuel permeation from anode to cathode.

At present, perfluorocarbon membranes are the most commonly used. Conventional perfluorocarbon membranes have a non-crosslinked perfluoroalkylene polymer main chain which contain proton-conductive functional groups. Nafion® membranes are a typical example thereof.

As reported, for example, by U.S. Pat. No. 6,444,343, Nafion® membranes demonstrate high conductivity and possess high power and energy density capabilities. However, use of Nafion® membranes in DMFCs is associated with disadvantages including very high cost, and a high rate of methanol permeation from the anode compartment, across the polymer electrolyte membrane, to the cathode. This “methanol crossover” lowers the fuel cell efficiency.

Alternative polymeric membranes have been proposed, among these the radiation grafted polymeric membranes attracted attention. As reported, for example by K. Scott et al., Journal of Membrane Science, 171 (2000), 119-130, ion exchange membranes are produced by grafting in which monomers are co-polymerized onto a pre-formed polymeric structure, eventually forming a new polymeric structure that is grown from the substrate. Grafting reactions are carried out by forming polymeric radicals in the substrate, a process that can be induced chemically or by ionizing radiation.

K. Scott et al., supra, investigates, inter alia, copolymers of LDPE with styrene produced by radiation grafting. In DMFC tests some fluorine free radiation grafted LDPE-PSSA (low density polyethylene/polystyrene sulphuric acid) membranes exhibit very low methanol diffusion coefficients, at least one order of magnitude lower than Nafion®, however have high electrical resistivity and an undesirable de-lamination of the catalyst layer to the membrane surface.

Another drawback of fluorine free polymeric membranes is connected to the presence of Nafion® in the catalyst layer of the electrodes. In general, it is believed that this material penetrates the catalyst layer and serves as an ionic bridge between the active sites of the catalyst and the membrane surface. This major breakthrough poses one of the greatest limitation in trying membranes alternative to Nafion®. If the membranes significantly differ in terms of chemical composition from Nafion® then the Nafion® solution dissolved into the electrode catalyst layer may be incompatible and generally may not promote good electrical contact or good adhesion between the different composite layers forming MEA. In its conclusion, K. Scott et al., supra, underlines that a major issue of the radiation grafted solid polymer membrane materials is the stability of MEA in term of lamination of catalyst layer to the membrane surface.

Summarizing, electrodes containing Nafion® are indicated as those providing the best performance in MEA in terms of ionic transport. At the same time a MEA based on an electrolyte membrane other than Nafion® is desirable either for economical reasons and for reducing the methanol cross-over phenomenon. However, fluorine free polymeric materials show poor performance and stability in a MEA with electrodes containing Nafion®e because of the chemical incompatibility.

### SUMMARY OF THE INVENTION

The Applicant perceived that the interaction between anode fluorinated material and electrolyte membrane fluorine free polymer could be improved in term of power density and operating times by improving the distribution of the catalyst.

The Applicant found that a proton exchange membrane fuel cell (PEMFC) based on a MEA wherein the anode catalyst content with respect to the anode fluorinated ionomer is higher in proximity of the electrolyte membrane than in the anode catalytic layer, provides effective power density even at a temperature of 40° C. or less at 1 atm.

Therefore, the present invention relates to a proton exchange membrane fuel cell comprising at least one membrane-electrode assembly including an electrolyte membrane based on a fluorine free polymer grafted with side chains containing proton conductive functional groups, and interposed between an anode and a cathode, the anode including a catalytic layer comprising a catalyst and a fluorinated ionomer, said catalytic layer having a fluorine/catalyst ratio that increases in a direction from the electrolyte membrane to an outer surface of the anode.

For the purpose of the present description and of the claims which follow, except where otherwise indicated, all numbers expressing amounts, quantities, percentages, and so forth, are to be understood as being modified in all instances by the term “about”. Also, all ranges include any combination of the maximum and minimum points disclosed and include any intermediate ranges therein, which may or may not be specifically enumerated herein.

In the following description and claims, the anode and the cathode can also be collectively referred to as “the electrodes”.

A proton exchange membrane fuel cells (PEMFCs) according to the invention can be fed with a fuel selected from formic acid, methanol, ethanol, dimethyl ether, dimethoxy and trimethoxy ethane, formaldehyde, trioxane, and ethylene glycol. Preferably, the fuel is methanol, more preferably used directly without a fuel reformer.

A preferred PEMFC according to the invention is a direct methanol fuel cell (DMFC).

In a preferred embodiment of the invention, the electrolyte membrane consists of a fluorine free polymer grafted with side chains containing proton conductive functional groups.

Preferably, the side chains containing proton conductive functional groups are grafted to the fluorine free polymer through an oxygen bridge.

Advantageously, the amount of grafting [Δp(%)] of said side chains is of from 10% to 250%, preferably of from 30% to 100%. The amount of grafting can be calculated according to the formula:

$$Δ p = \frac{{w}_{f} - {w}_{i}}{{w}_{i}} 100$$

wherein wᵢ and w_{f} are the dry weight of the membrane, respectively, before and after the grafting process.

Advantageously, the grafting is a radiation-grafting. The radiation-grafting is obtained by irradiation process known in the art like, for example, that disclosed by WO04/004053, in the Applicant's name.

Preferably, the fluorine free polymer is a polyolefin. Polyolefins which may be used in the present invention may be selected from: polyethylene, polypropylene, polyvinylchloride, ethylene-propylene copolymer (EPR) or ethylene-propylene-diene terpolymer (EPDM), ethylene vinyl acetate copolymer (EVA), ethylene butylacrylate copolymer (EBA), polyvinylidenedichloride, polychloroethylene. Polyethylene is particularly preferred. The polyethylene may be: high density polyethylene (HDPE) (d=0.940−0.970 g/cm³); medium density polyethylene (MDPE) (d=0.926−0.940 g/cm³); low density polyethylene (LDPE) (d=0.910−0.926 g/cm³). Low density polyethylene (LDPE) is particularly preferred.

Advantageously, the side chains are selected from any hydrocarbon polymer chain which contains proton conductive functional groups or which may be modified to provide proton conductive functional groups. The side chains are obtained by graft polymerization of unsaturated hydrocarbon monomers, said hydrocarbon monomers being optionally chlorinated or brominated. Said unsaturated hydrocarbon monomer may be selected from: styrene, chloroalkylstyrene, α-methylstyrene, α,β-dimethylstyrene, α,β,β-trimethylstyrene, ortho-methylstyrene, p-methylstyrene, meta-methylstyrene, p-chloromethylstyrene, acrylic acid, methacrylic acid, vinylalkyl sulfonic acid, divinylbenzene, triallylcyanurate, vinylpyridine, and copolymers thereof. Styrene and α-methylstyrene are particularly preferred.

According to a preferred embodiment, the proton conductive functional groups may be selected from sulfonic acid groups and phosphoric acid groups. Sulfonic acid groups are particularly preferred.

The percentage of proton conductive functional groups present in the electrolyte membrane material of the invention [Δg(%)] is defined as the membrane weight gain after the addition of such groups, e.g. after the sulfonation process, and can be calculated according to the formula already mentioned above in connection with the calculation of the amount of grafting [Δp(%)], mutatis mutandis, i.e. wᵢ and w_{f} are the dry weight of the membrane, respectively, before and after the addition of the proton c conductive functional groups. Preferably, Δg(%) is of from 10% to 100%, more preferably from 20% to 70%.

As for the anode catalytic layer, the catalyst can be selected from platinum, gold, and tungsten oxides. Preferred catalyst for the anode catalytic layer is platinum, and is advantageously promoted to enhance the fuel oxidation. Examples of catalyst promoters are chrome, iron, tin, bismuth, ruthenium, molybdenum, osmium, iridium, titanium, rhenium, tungsten, niobium, zirconium, tantalum. Preferred is a catalyst promoter selected from at least one of tin, molybdenum, osmium, iridium, titanium and ruthenium, either in metallic or oxide form. An example of catalyst promoter in oxide form is hydrous ruthenium oxide. When the at least one promoter is in metallic form, an alloy with the catalyst is preferred. Alloys of at least one catalyst promoter with platinum are particularly preferred. Preferred is a platinum-ruthenium alloy (Pt—Ru), the ratio Pt:Ru possibly ranging from 9:1 to 1:1.

The fluorine/catalyst ratio according to the invention is calculated on the basis of the catalyst content without considering the promoter optionally present in the catalytic layer.

The cathode of the present invention comprises a catalytic layer preferably including a catalyst and a fluorinated ionomer.

The cathode catalyst can be selected from platinum; gold; derivatives of transition metal macrocycles such as derivatives of iron or cobalt porphyrin, phthalocyanine, dimethylglyoxime; and mixed transition metal oxides such as ruthenium-molybdenum-selenium oxide. Preferred catalyst for the cathode catalytic layer is platinum.

Advantageously, at least one of the anode and the cathode catalysts is dispersed on electrically conductive carbon particles. Preferably, the carbon particles have a surface area higher than 100 m²/g. Example of carbon particles are high surface area graphite, carbon blacks such as Vulcan® XC-72 (Cabot Corp.), Ketjenblack® (Akzo Nobel Polymer Chemicals) and acetylene black, or activated carbons.

Preferably, the catalyst is dispersed on carbon particles in an amount of from 10 wt % to 90 wt %. As for the anode catalyst, the dispersion percentage advantageously ranges from 40 wt % to 85 wt %. As for the cathode catalyst, the dispersion percentage advantageously ranges from 20 wt % to 70 wt %.

Examples of fluorinated ionomers are perfluorinated compounds optionally containing sulphonic groups. Preferably, the fluorinated ionomer is perfluoro-3,6-dioxa-4-methyl-7-octene-sulfonic acid (Nafion®).

Advantageously, the amount of fluorinated ionomer is of from 5 wt % to 95 wt % of the total components of the catalytic layer. Preferably is of from 10 wt % to 45 wt %.

Preferably, each electrode shows a catalyst content of less than 10 mg/cm², more preferably less than 5 mg/cm².

Optionally, the catalytic layer of at least one of the anode and the cathode is provided with a support. Examples of supports are carbon cloth and carbon paper.

Optionally, a diffusion layer is provided in contact with the surface of the catalytic layer of at least one of the anode and the cathode opposite to that forming the interface with the electrolyte membrane. Optionally, the diffusion layer is interposed between the support and the catalytic layer. The diffusion layer is used to improve the dispersion of the reactant materials (fuel and air) from outside the MEA to the catalytic layer, and the elimination of the reaction by-products from the MEA. For example, the diffusion layer is made of acetylene carbon. Examples of carbons suitable for the diffusion layer are those already listed above in connection with the carbon particles on which the catalyst can be dispersed.

Advantageously, each electrode further comprises a binder made, for example, of a polymeric material. Such polymeric material can be a hydrocarbon polymer like polyethylene or polypropylene, partially fluorinated polymers like ethylene-clorotrifluoroethylene, or perfluorinated polymers such as polytetrafluoroethylene (PTFE) or polyvinylidene fluoride. The binder is of help for assuring the structural integrity of the electrodes. Also, the binder can play a role in the regulation of the hydrophobicity of the electrodes.

The anode and the cathode join the electrolyte membrane by the catalytic layer thereof, and the electrolyte membrane polymer and each catalytic layer interpenetrate. Each interpenetration zone is hereinafter referred to as “interface”. The interface is where the three-phase point is established among the fuel or oxygen, electrolyte membrane proton conducting groups and catalyst. The nature of this interface plays a critical role in the electrochemical performance of a fuel cell.

The interface electrolyte membrane polymer/anode catalytic layer can be of from to 3 μm to 10 μm thick.

The interface electrolyte membrane polymer/cathode catalytic layer can be of from to 3 μm to 15 μm thick.

According to the invention, the fluorine/catalyst ratio (hereinafter referred to as “F/Pt”) increases in a direction from the electrolyte membrane to an outer surface of the anode. This means, for example, that such ratio is lower at the interface than in the anode catalytic layer.

As shown in the following examples, in known MEAs with a fluorine free electrolyte membrane the F/Pt value is substantially constant throughout the anode catalytic layer, interface included, because only the anode contains fluorine and catalyst. The MEA of the invention shows an interface electrolyte membrane/anode enriched in catalyst with respect to the fluorine ionomer of the anode catalytic layer.

This feature is indicative of an improved synergetic interaction between membrane and anode of the present invention. The interfaces are rich in proton conducting groups from the electrolyte membrane polymer and in catalyst particles, and the depletion in fluorine from the hydrophobic component of the ionomer allows a most effective activity of the catalyst.

The proton exchange fuel cell of the invention is obtained preparing an electrolyte membrane, an anode and a cathode, and assembling them under pressure, preferably by heating at a temperature of from 80° C. to 150° C. preferably the pressure is of from 1 to 5 bars.

At least the catalytic layer of the anode, but advantageously that of the cathode too, can be prepared by depositing over a support an intimate admixture of catalyst and fluorinated ionomer, for example according to the process described in A. S. Aricò, A. K. Shukla, K. M. el-Khatib, P. Creti, V. Antonucci, J. Appl. Electrochem. 29 (1999) 671.

In a first step the catalyst, advantageously finely dispersed in the carbon particles, can be sonically dispersed in water, then the ionomer is added, for example in form of alcoholic suspension. The admixture is then spread over a support, preferably pre-heated at a temperature of 50-100° C., until the desired loading is achieved. After complete elimination of the solvent, the resulting electrode is assembled with the membrane, advantageously in dry state.

In another aspect, the present invention relates to a portable equipment powered with at least one proton exchange membrane fuel cell comprising at least one membrane-electrode assembly including an electrolyte membrane based on a fluorine free polymer grafted with side chains containing proton conductive functional groups, and interposed between an anode and a cathode, the anode including a catalytic layer comprising a catalyst and a fluorinated ionomer, said catalytic layer having a fluorine/catalyst ratio that increases in a direction from the electrolyte membrane to an outer surface of the anode.

Examples of portable equipments according to the invention are cellular phones, notebook computers, video cameras, and personal digital assistants.

### BRIEF DESCRIPTION OF THE DRAWINGS

The invention will be further illustrated hereinafter with reference to the following examples and figures, wherein:

FIG. 1 schematically shows a PEMFC according to the invention;

FIGS. 2a and 2b show respectively polarizations and power output curves recorded for MEA of the invention and comparative MEA;

FIG. 3 show the values of F/Pt ratio in a direction from the electrolyte membrane to the outer surface of the anode in a MEA according to the invention and in MEAs according to the prior art;

FIGS. 4a and 4b are energy dispersive X-ray (EDAX) spectra of the anode catalytic layer of a MEA according to the invention, respectively at 0 μm and 40 μm from the electrolyte membrane.

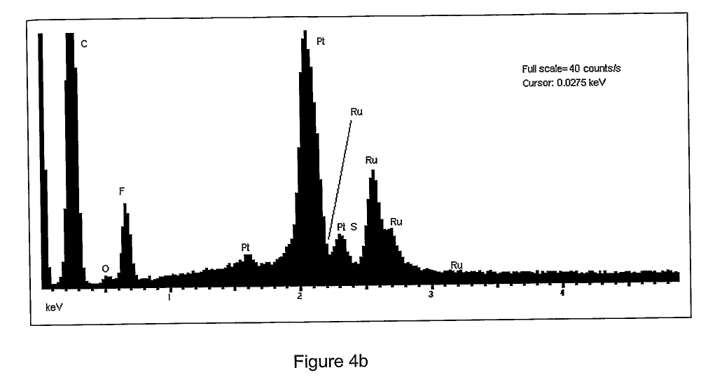

### DETAILED DESCRIPTION OF THE PREFERRED EMBODIMENTS

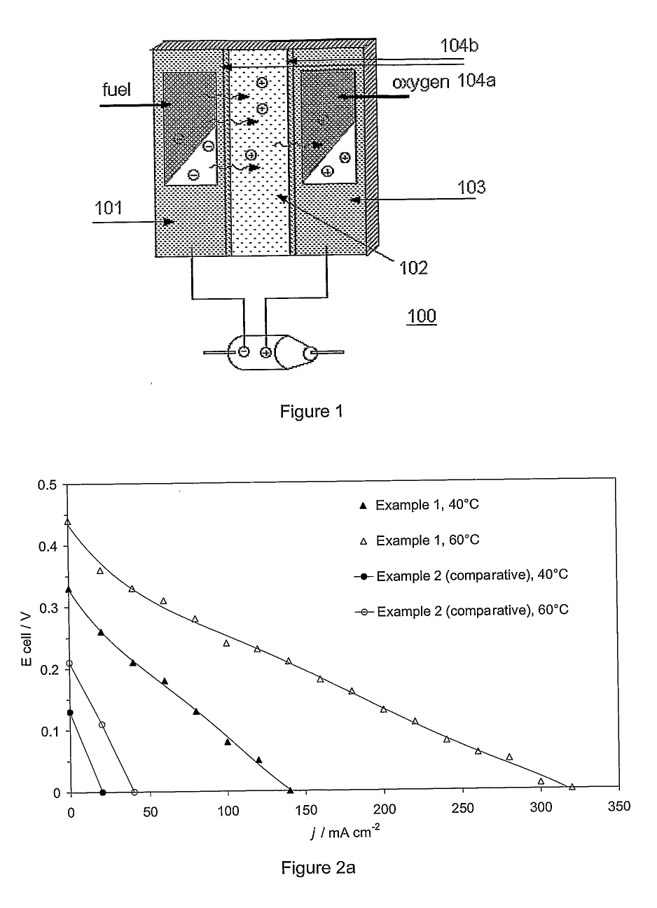

FIG. 1 schematically illustrates a PEMFC (100). The PEMFC (100) comprises an anode (101), a cathode (103) and an electrolyte membrane (102) positioned between them. A first and a second interfaces (104a, 104b) are between the electrolyte membrane and, respectively, the anode (101) and the cathode (103).

According to a preferred embodiment of the invention, methanol is fed as fuel to the anode (101) to be oxidized. The electric power in form of direct current (DC) can be exploited as such by a portable device or converted into alternate current (AC) via a power conditioner (not illustrated). From anode (102) an effluent flows which can be composed by unreacted fuel and/or reaction product/s, for example water and/or carbon dioxide.

### Example 1

### Membrane Electrode Assembly for Direct Methanol Fuel Cell (DMFC)

### a) Electrolyte Membrane Preparation:

A 40 μm low density polyethylene (LDPE) film (40 μm) was irradiated in air with γ-rays using a ⁶⁰-irradiation source to a total radiation dose of 0.05 MGy, at a radiation rate of 60 rad/s. The irradiated film was left in air at room temperature for 168 hours.

Styrene monomer (purity ≧99% from Aldrich) was washed with an aqueous solution of 30% sodium hydroxide, then washed with distilled water until neutral pH. The treated styrene was dried over calcium chloride (CaCl₂) and distilled under reduced pressure. A styrene/methanol solution (50:50 vol. %) containing 2 mg/ml of ferrous sulfate (FeSO₄.7H₂O) was prepared using a steel reactor equipped with a reflux condenser. The steel reactor was heated in a water bath until the solution boiling point.

The irradiated LDPE film was immersed in 100 ml of this styrene/methanol solution (grafting mixture). After 2.5 hours (grafting time) the LDPE film was removed from the reaction vessel, washed with toluene and methanol three times, then dried in air and vacuum at room temperature to constant weight.

The grafted LDPE film was immersed in a concentrated sulfuric acid solution (96%) and heated for 2.8 hours at 98° C. in a steel reactor supplied with reflux condenser. Thereafter, the film was taken out of the solution, washed with different aqueous solutions of sulfuric acid (80%, 50% and 20% respectively), and finally with distilled water until neutral pH. The film was then dried in air at room temperature and after in vacuum at 50° C. to constant weight obtaining an electrolyte membrane.

The amount of grafted polystyrene [Δp(%)] and sulfonation degree [Δg(%)] resulted Δp=83% and Δg=53%. The electrolyte membrane had a final thickness of 73 μm.

### b) Determination of the Electrolyte Membrane Ion Exchange Capacity (IEC)

A sample (10 cm²) of the electrolyte membrane obtained in a) was dried in a vacuum oven at 80° C. for 2 hours, and the dry weight (m_{dry}) determined. After, the membrane was swelled in water and immersed in 20 ml of 1M NaCl for 18 hours at room temperature in order to exchange of H⁺ ions from the polymer with Na⁺ ions present in the solution. Finally, the solution containing the membrane was titrated with 0.01M NaOH monitoring pH during the titration.

Plotting the pH as function of the NaOH added volume, the equivalent volume (V_{eq}) and the IEC of the sample was determined according to the equation:

$$IEC = \frac{{V}_{eq} \cdot [ NaOH ]}{{m}_{dry}} .$$

The ion exchange capacity value was 2.84 meq/g.

### c) Electrode Materials and Structure

Anode and cathode had a composite structure formed by a thin (about 20 μm) diffusion layer and a catalytic layer, sequentially deposited on PTFE treated carbon cloth (AvCarb™ 1071 HCB) 0.33 mm thick.

The diffusion layer was made from acetylene carbon and 20 wt % of PTFE, with a final carbon loading of 2 mg/cm².

The anode catalytic layer was a mixture of Nafion® ionomer and 60 wt % PtRu/Vulcan® XC-72 powder (E-TEK), with a 3:1 powder/Nafion® ratio (dry wt %) and a total Pt content of 2.1 mg/cm² (catalyst ink).

The cathode catalytic layer was a mixture of Nafion® ionomer and 30 wt % Pt/Vulcan® XC-72 powder (E-TEK), with a 3:1 powder/Nafion® ratio (dry wt %), being the total Pt content of 2.3 mg/cm² (catalyst ink).

### d) Diffusion Layers Preparation

A 18×12 cm² piece of PTFE treated carbon cloth 0.33 mm thick was fixed onto a metallic plate pre-heated at 40° C., the temperature of the plate was then raised to 80° C.

650 mg of finely grinded acetylene black were sonicated for 10 minutes with 10.4 mg of deionized water and 10.4 mg of isopropyl alcohol. Next, further 0.2 ml of 60 wt % PTFE suspension in water (Aldrich), 5.2 mg of water and 5.2 mg of isopropyl alcohol were added to the mixture, which was sonicated for 15 minutes. The resulting slurry was sprayed over the carbon cloth of point c) until a final loading of 2 mg/cm² of carbon. The deposited layer was left to dry at 90° C. in air, then heat treated at 350° C. for four hours in an oven with air flux, increasing the temperature at a rate of 5° C./min.

### e) Anode Preparation

A 6×6 cm² piece of diffusion layer/support of point d) was cut and coated with the anodic catalytic layer as from point c). Prior to the deposition, the diffusion layer/support was heated at 80° C. onto a metallic plate.

273.2 mg of 60% PtRu/Vulcan® powder (E-TEK) were dispersed in water, sonicated for 10 minutes, added with 2.70 g of a 5 wt % Nafion® dispersion (Aldrich), and further treated for 20 minutes. The resulting catalyst ink was spread over the gas diffusion layer until a final Pt loading of 2 mg/cm². After each series of 2-3 depositions, the solvent was evaporated under air stream. The resulting anode was then left to dry in air for 18 hours and room temperature.

### f) Cathode Preparation:

A 6×6 cm² piece of diffusion layer/support of point d) was cut and coated with the cathodic catalytic layer as from point c). Prior to the deposition, the diffusion layer/support was heated at 80° C. onto a metallic plate.

360 mg of 30% Pt/Vulcan® powder (E-TEK) were dispersed in water, sonicated for 10 minutes, added with 3.55 g of a 5 wt % Naflon® dispersion (Aldrich), and further treated for 20 minutes. The resulting catalyst ink was spread over the gas diffusion layer until a final Pt loading of 2 mg/cm². After each series of 2-3 depositions, the solvent was evaporated under air stream. The resulting cathode was then left to dry in air for 18 hours and room temperature.

### g) Membrane/Electrode Assembly (MEA) Preparation

A MEA was prepared using the electrodes obtained in step e) and f), and the electrolyte membrane described in a).

A 5×5 cm² electrolyte membrane and 2.5×2.5 cm² electrodes, both anode and cathode, were used for MEA preparation. The two electrodes were placed respectively on either side of the electrolyte membrane, with their catalytic layer facing the electrolyte membrane. The whole was sandwiched between two PTFE sheets and hot assembled using an hydraulic press (ATS FAAR). The press platens (30 cm²) were previously heated at 80° C. After inserting the MEA the platen temperature was raised to 100° C., then a 3 bar pressure was applied for 1.5 minutes.

### Example 2

### Membrane Electrode Assembly for DMFC Having a Grafted Irradiated Membrane and Commercial ELAT Electrodes (E-TEK) (Comparative Example)

The electrolyte membrane described in example 1,a) was assembled with two ELAT® (E-TEK) commercial gas diffusion electrodes for DMFCs.

Each electrode (anode and cathode) consisted of a three layer structure formed by a carbon cloth support (0.35 mm), a thick microporous wet proof diffusion layer (0.45-0.55 mm) and a catalytic layer.

The anode (A-11 electrode) catalytic layer is prepared from 60% PtRu (1:1) on Vulcan® XC-72 and PTFE (a binder) and functionalized by spraying over a Nafion ionomer suspension. The cathode (A-6 electrode) catalytic layer is prepared from 40% Pt on Vulcan® XC-72 and PTFE (the binder) and functionalized by spraying over a Nafion ionomer suspension. The Pt load on each electrode was 2 mg/cm².

After spraying a Nafion® ionomer suspension (Aldrich) over the catalytic layers of both anode and cathode for a final Nafion® content of 0.6 mg/cm² (dry weight), a membrane electrode assembly was prepared using the procedure described in example 1,g). The geometrical active electrode area of the electrode/membrane assembly was 5 cm².

### Example 3

### Electrochemical Characterization of MEAs in CH₃OH/Air Fuel Cell Configuration

MEAs of Example 1 and 2 were each installed in a single cell test system (Globo Tech Inc), containing two copper current collector end plates and two graphite plates containing rib channel patterns allowing the passage of an aqueous solution to the anode and humidified air to the cathode.

After inserting the MEAs assembly into their single test housing, the cell was equilibrated at 30° C. using distilled water and humidified air. Water was supplied to the anode through a peristaltic pump and a pre-heater maintained at the cell temperature. Humidified air was fed to the cathode at atmospheric pressure, and the air humidifier was maintained at a temperature 10° C. above the cell temperature.

The single cell was connected to an AC impedance Analyser type 4338B (Agilent), and the cell resistance (expressed in Ωcm²) was measured at a fixed frequency of 1 KHz and under open circuit conditions. When a constant value of cell resistance was reached, the anode was fed with 1M methanol solution at a feed rate of 2.4 ml/min, while the air flux at the cathode was changed to 500 ml/min. The cell resistance at open circuit and 30° C. was measured again, and the dynamic polarization curve recorded. The cell was then stepwise warmed up to 60° C., recording the cell resistances and polarization curves at different temperatures.

Cell resistance (R_{cell}), open circuit voltage (OCV) and maximum power output density (Pₘₐₓ), all recorded at 40 and 60° C. are reported in Table 1.

TABLE 1

| Ex- | R_{cell} (Ωcm²) | | OCV (V) | | Pₘₐₓ (mW/cm²) | |
|---|---|---|---|---|---|---|
| ample | 40° C. | 60° C. | 40° C. | 60° C. | 40° C. | 60° C. |
| 1 | 0.13 | 0.09 | 0.33 | 0.44 | 10.8 | 29.4 |
| 2 | 0.11 | — | 0.13 | 0.21 | — | 2.0 |

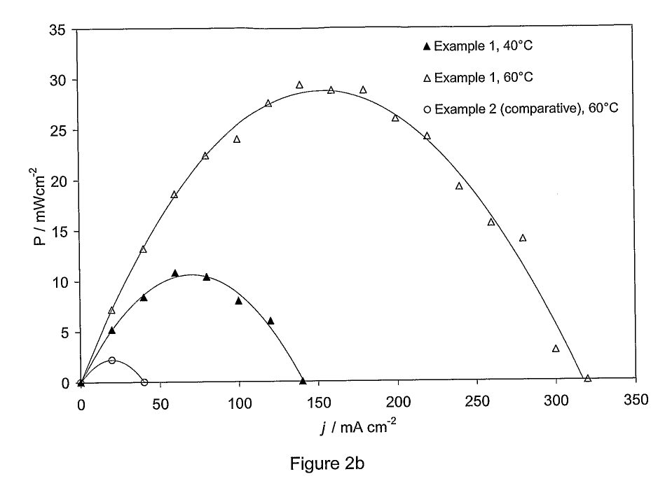

FIGS. 2a and 2b show respectively polarizations and power output curves recorded at 40 and 60° C.

Both MEA are characterized by a low cell resistance, however the MEA of example 1 presents high open circuit values even at 40° C., pointing for an effective membrane electrode interface. The maximum power densities at these temperatures and atmospheric pressure were 10.8 and 28 mW/cm².

The MEA of Example 2 showed to be unsuitable. Data reported in both Table 1 and FIG. 1 clearly show that the membrane electrode assembly of this example is not effective for DMFC, as the recorded OCV values and power densities are very low even at 60° C.

### Example 4

### Preparation of a Membrane/Electrode Assembly and Characterization of its Interfaces

### a) Electrolyte Membrane Preparation:

A membrane was prepared according to procedure described in example 1, excepting for grafting mixture that contained 30 vol % of styrene monomer and 70 vol. % of methanol. The grafting and sulfonation times were 330 and 240 minutes respectively, and the final grafting and sulfonation degrees were 71% and 45% respectively. The ion exchange capacity of this membranes was evaluated to be 2.93 meq/g.

### b) Membrane/Electrode Assembly (MEA) Preparation

A 5×5 cm² electrolyte membrane of point a), and 2.5×2.5 cm² electrodes, both anode and cathode, as prepared in Example 1, were used for MEA preparation.

The two electrodes were placed on either side of the electrolyte membrane, with their catalytic layer facing the electrolyte membrane, and the whole was sandwiched between two PTFE sheets and hot assembled using an hydraulic press (ATS FAAR). The press platens (30 cm²) were previously heated at 80° C., and, after inserting the MEA, the temperature was raised to 100° C. and a 3 bar pressure was applied for 1.5 minutes.

### c) Interfaces Characterization

The interface characterization was performed by taking out a sample from the core of the MEA of point a) as from the following. First, the MEA was cut into two portions according to a plane substantially perpendicular to the longitudinal thickness of the anode, cathode and electrolyte membrane, said plane being in substantially central position with respect to the longitudinal extension of the MEA. One of the portions was then cut according to two planes substantially perpendicular to the plane of the first cut, thus obtaining a desired sample.

The sample was fixed with a conductive ribbon to a holder with a vertical wall, then metallized by sputtering with 2-3 nm of a silver layer.

The composition was observed with a scanning electron microscope (Hitachi S-2700) and the variation of F, S, Pt and Ru elemental composition from the electrolyte membrane/electrode interfaces towards the respective electrodes was followed by EDAX analysis (Oxford ISIS 300 instrument).

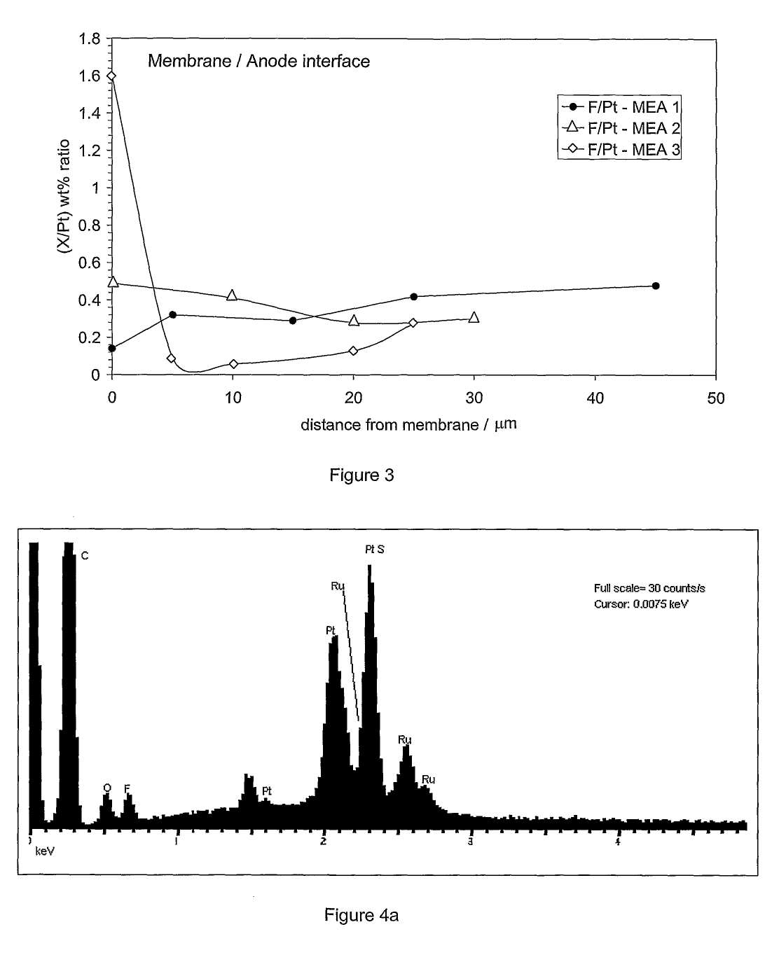

The elemental analysis was carried out on 20 μm long and 5 μm wide windows located on a line scan parallel to the cross section. The first point (0 μm) was recorded by centering the EDAX window on the line defining the center of the interface anode/electrolyte membrane. Several line scans at different position of the cross-section were analyzed and the average values are reported in Table 2. This table also set forth the recorded ratios F/S and S/Pt. FIG. 3 show the curve of F/Pt ratio values of in a direction from the electrolyte membrane to the outer surface of the anode in a MEA.

### Example 5

### Preparation of a Membrane/Electrode Assembly and Characterization of its Interfaces (Comparative Example)

### a) Electrolyte Membrane Preparation

The electrolyte membrane was substantially prepared according to example 1,a) to have a final grafting and sulfonation degrees of 71% and 32%, respectively. The grafting and sulfonation time were 330 and 180 minutes, respectively. The ion exchange capacity of this membranes was evaluated to be 2.89 meq/g.

### b) Anode and Cathode Preparation

The electrodes were prepared according to example 1, but with an extra layer of Nafion® ionomer (0.6 mg/cm² dry weight) sprayed on the surface of each electrode as described by Scott et al., supra.

### c) Membrane/Electrode Assembling Preparation

The membrane and the electrodes were assembled as described in Example 4.

### d) Interfaces Characterization

The characterization procedure of example 4 was applied. The results are set forth in Table 2 and FIG. 3.

Contrarily to what recorded for the MEA of Example 4 according to the invention, the F/Pt ratio values provided by the MEA of this comparative example decrease in a direction from the electrolyte membrane to the outer surface of the anode, evidencing that the catalyst is “covered” by the fluorine ionomer. In other words, in this MEA less of Pt catalyst is exposed at the interface as shown by the higher (F/Pt) values with respect to the catalytic layer of the anode.

### Example 6

### Preparation of a Membrane/Electrode Assembly and Characterization of its Interfaces (Comparative Example)

### a) Electrolyte Membrane Preparation:

The electrolyte membrane was prepared substantially according to Example 5.

### b) Anode and Cathode Preparation

Two electrodes with a composition 60% PtRu/C-ELAT and 40% Pt/C-ELAT was purchased from E-TEK, and described in Example 2, were used.

### c) Membrane/Electrode Assembling Preparation

The membrane and the electrodes were assembled as described in example 4

### d) Interfaces Characterization

The characterization procedure of example 4 was applied. The results are set forth in Table 2 and FIG. 3.

Contrarily to what recorded for the MEA of Example 4 according to the invention, the F/Pt ratio values provided by the MEA of this comparative example decrease in a direction from the electrolyte membrane to the outer surface of the anode, evidencing that the catalyst is “covered” by the fluorine ionomer.

TABLE 2
Experimental (F/Pt), (F/S) and (S/Pt) recorded at different
positions from the center of the first interface (anode interface)

| | | Distance (μm) | | |
|---|---|---|---|---|
| | | 0 ± 2.5 | 5 ± 2.5 | 20 ± 2.5 |
| (F/Pt) | Example 4 | 0.14 | 0.32 | 0.42 |
| | Example 5 | 0.49 | 0.45 | 0.28 |
| | Example 6 | 1.60 | 0.09 | 0.13 |
| (F/S) | Example 4 | 0.23 | 8.0 | 11.3 |
| | Example 5 | 0.56 | 5.0 | 3.11 |
| | Example 6 | 0.10 | 0.87 | 2.48 |
| (S/Pt) | Example 4 | 0.60 | 0.04 | 0.037 |
| | Example 5 | 0.87 | 0.084 | 0.09 |
| | Example 6 | 16.2 | 0.10 | 0.05 |

1-32. (canceled)

33. A proton exchange membrane fuel cell comprising at least one membrane-electrode assembly comprising an electrolyte membrane based on a fluorine free polymer grafted with side chains containing proton conductive functional groups, and interposed between an anode and a cathode, the anode comprising a catalytic layer comprising a catalyst and a fluorinated ionomer, said catalytic layer having a fluorine/catalyst ratio that increases in a direction from the electrolyte membrane to an outer surface of the anode.

34. The proton exchange membrane fuel cell according to claim 33, comprising a direct methanol fuel cell.

35. The proton exchange membrane fuel cell according to claim 33, wherein the electrolyte membrane consists of a fluorine free polymer grafted with side chains containing proton conductive functional groups.

36. The proton exchange membrane fuel cell according to claim 33, wherein the side chains containing proton conductive functional groups are grafted to the fluorine free polymer through an oxygen bridge.

37. The proton exchange membrane fuel cell according to claim 33, wherein the side chains comprise 10% to 250% proton conductive functional groups grafted to the fluorine free polymer.

38. The proton exchange membrane fuel cell according to claim 37, wherein the side chains comprise 30% to 100% proton conductive functional groups grafted to the fluorine free polymer.

39. The proton exchange membrane fuel cell according to claim 37, wherein the side chains containing proton conductive functional groups are radiation-grafted.

40. The proton exchange membrane fuel cell according to claim 37, wherein the fluorine free polymer is a polyolefin.

41. The proton exchange membrane fuel cell according to claim 40, wherein the polyolefin is selected from: polyethylene, polypropylene, polyvinylchloride, ethylene-propylene copolymer or ethylene-propylene-diene terpolymer, ethylene vinyl acetate copolymer, ethylene butylacrylate copolymer, polyvinylidenedichloride, and polychloroethylene.

42. The proton exchange membrane fuel cell according to claim 41, wherein the polyolefin is polyethylene.

43. The proton exchange membrane fuel cell according to claim 42, wherein polyethylene is low density polyethylene.

44. The proton exchange membrane fuel cell according to claim 33, wherein the side chains are selected from: styrene, chloroalkylstyrene, α-methylstyrene, α,β-dimethylstyrene, α,β,β-trimethylstyrene, ortho-methylstyrene, p-methylstyrene, meta-methylstyrene, p-chloromethylstyrene, acrylic acid, methacrylic acid, vinylalkyl sulfonic acid, divinylbenzene, triallylcyanurate, vinylpyridine, and copolymers thereof.

45. The proton exchange membrane fuel cell according to claim 44 wherein the side chains are selected from styrene and α-methylstyrene.

46. The proton exchange membrane fuel cell according to claim 33, wherein the proton conductive functional groups are selected from sulfonic acid groups and phosphoric acid groups.

47. The proton exchange membrane fuel cell according to claim 46, wherein the proton conductive functional groups are sulfonic acid groups.

48. The proton exchange membrane fuel cell according to claim 33, wherein the side chains comprise 10% to 100% proton conductive functional groups, based on a percentage [Δg(%)].

49. The proton exchange membrane fuel cell according to claim 48, wherein the side chain comprises 20% to 70% proton conductive functional groups based on a percentage [Δg(%)].

50. The proton exchange membrane fuel cell according to claim 33, wherein the catalyst of the anode catalytic layer is selected from optionally promoted platinum, gold, and tungsten oxides.

51. The proton exchange membrane fuel cell according to claim 50, wherein platinum is promoted by rhutenium.

52. The proton exchange membrane fuel cell according to claim 51, wherein platinum and rhutenium form an alloy.

53. The proton exchange membrane fuel cell according to claim 33, wherein the cathode comprises a catalytic layer comprising a catalyst and a fluorinated ionomer.

54. The proton exchange membrane fuel cell according to claim 53, wherein the catalyst is selected from platinum; gold; derivatives of transition metal macrocycles; mixed transition metal oxides, and ruthenium-molybdenum-selenium oxide.

55. The proton exchange membrane fuel cell according to claim 54, wherein the catalyst is platinum.

56. The proton exchange membrane fuel cell according to claim 33, wherein the anode catalyst is dispersed on electrically conductive carbon particles.

57. The proton exchange membrane fuel cell according to claim 56, wherein the carbon particles have a particle surface area higher than 100 m²/g.

58. The proton exchange membrane fuel cell according to claim 56, comprising 10 wt % to 90 wt % catalyst dispersed on carbon particles.

59. The proton exchange membrane fuel cell according to claim 33, wherein the fluorinated ionomer is perfluoro-3,6-dioxa-4-methyl-7-octene-sulfonic acid.

60. The proton exchange membrane fuel cell according to claim 33, wherein the amount of fluorinated ionomer is 5 wt % to 95 wt % of the total components of the catalytic layer.

61. The proton exchange membrane fuel cell according to claim 33, comprising less than 10 mg/cm² catalyst.

62. The proton exchange membrane fuel cell according to claim 61, wherein the catalyst is less than 5 mg/cm².

63. The proton exchange membrane fuel cell according to claim 33, wherein the anode is prepared by depositing an intimate admixture, in the form of a suspension, of catalyst and fluorinated ionomer over a support, by drying said admixture and assembling the anode with the electrolyte membrane.

64. Portable equipment powered with at least one proton exchange membrane fuel cell comprising at least one membrane-electrode assembly comprising an electrolyte membrane based on a fluorine free polymer grafted with side chains containing proton conductive functional groups, and interposed between an anode and a cathode, the anode comprising a catalytic layer comprising a catalyst and a fluorinated ionomer, said catalytic layer having a fluorine/catalyst ratio that increases in a direction from the electrolyte membrane to an outer surface of the anode.
